(19) United States
(12) Patent Application Publication
(10) Pub. No.: US 2014/0029089 A1
(43) Pub. Date: Jan. 30, 2014

(54) STEREOMICROSCOPE HAVING FOUR OBSERVATION CHANNELS

(71) Applicant: Leica Microsystems (Schweiz) AG, Heerbrugg (CH)

(72) Inventor: Michael GUENTERT, Heerbrugg (CH)

(73) Assignee: Leica Microsystems (Schweiz) AG, Heerbrugg (CH)

(21) Appl. No.: 13/947,233

(22) Filed: Jul. 22, 2013

(30) Foreign Application Priority Data
Jul. 30, 2012 (DE) 10 2012 213 369.0

(51) Int. Cl. G02B 21/22

(52) U.S. Cl. CPC G02B 21/22
USPC 359/377

(57) ABSTRACT

A stereomicroscope (1) has two main observer's beam paths (24a, 24b) and two assistant observer's beam paths (23a, 23b) that pass through a main objective (2), such that pupils (4a, 4b; 3a, 3b) of the four beam paths are respectively formed in the objective plane, where the stereo bases (9, 10), connecting the centers of a pupil pair, of the main observer's and assistant observer's beam paths intersect at an angle, and has a device for illumination incoupling comprising an illumination deflection element (8) arranged such that illumination light is couplable simultaneously into all four observation beam paths (24a, 24b; 23a, 23b), imaginary connecting lines (12, 13) extending perpendicular to and between the axes respectively of an assistant observer's beam path and of a main observer's beam path, and the illumination deflection element arranged such that two parallel connecting lines are located in the plane of the illumination deflection element.

### CROSS REFERENCE TO RELATED APPLICATIONS

This application claims priority of German patent application number 10 2012 213 369.0 filed Jul. 30, 2012, the entire disclosure of which is incorporated by reference herein.

### FIELD OF THE INVENTION

The present invention relates to a four-beam stereomicroscope, in particular for ophthalmic surgery, having two main observer's beam paths and two assistant observer's beam paths that pass through a main objective of the stereomicroscope, with the result that pupils of the main observer's and assistant observer's beam paths are respectively formed in the objective plane, where the stereo bases, connecting the centers of a pupil pair, of the main observer's and assistant observer's beam paths intersect at an angle. A “stereo base” is understood in the context of this Application as the imaginary line that extends in the objective plane between the centers of the pupils of a pupil pair of the main observer's and assistant observer's beam paths, respectively. The stereo base of the main observer's beam paths crosses the stereo base of the assistant observer's beam paths in such a way that the stereo bases intersect at an angle.

### BACKGROUND OF THE INVENTION

DE 10 2009 037 022 A1 describes a surgical microscope having a main objective through which a binocular main observer's beam path and a binocular co-observer's beam path pass, said observers' beam paths each having a pair of observation pupils in the objective plane. Lines connecting the centers of these pupil pairs (said lines referred to in the context of the present Application as “stereo bases”) cross or intersect one another at an angle. According to the document cited, this angle, which is usually equal to 90°, can be modified by means of a displacement device, in which context a displacement of the center point of the stereo base of the co-observer's beam path can simultaneously occur.

The use of four-beam surgical microscopes ensures that both the main observer and the co-observer (assistant) have available to them the full intensity, and thus the full image brightness, of the respective observer's beam path. With two-beam surgical microscopes, conversely, the assistant's beam path is coupled out of the main observer's beam path. For ophthalmic procedures in particular, however, the light loss resulting therefrom is not always acceptable. The red reflex illumination used, for example, in cataract operations is of low intensity, since on the one hand not all of the illumination light is reflected at the retina of the eye, and on the other hand the illumination intensity on the retina must not be too high so as not to damage it. Four-beam surgical microscopes have proven successful here; for example, by means of a common zoom system, the magnification can be selected to be identical on all four channels (observers' beam paths). It is further desirable for the red reflex to be visible in the same manner for the main observer (surgeon) and for the co-observer (assistant). A prerequisite for creation of the red reflex is that the angle between the observation beam path and the illumination beam path be as small as possible. This applies in the same way to the main and assistant observer's beam paths. This is the reason for the frequent use of the previously mentioned pupil arrangement, in which the pupil pairs of the main observer's beam path in the objective plane are arranged with a 90° rotation with respect to the pupil pairs of the assistant observer's beam path, i.e. cross one another, the corresponding stereo bases enclosing an angle of 90°.

Whereas with such an arrangement the viewing direction of the main observer is perpendicular to the stereo base of the two main observer's beam paths (or the binocular main observer's beam path), the viewing direction of the assistant observer is rotated 90° with respect thereto. Also known are so-called “zero-degree” assistant devices that allow the assistant's tube to be rotated or offset 180 degrees.

The previously mentioned DE 10 2009 037 022 A1 makes possible, by means of the aforesaid displacement device, a selectably adjustable orientation of the co-observer's tube relative to the main observer's tube.

DE 102 08 594 A1 deals with illumination incoupling for an optical viewing device, such as a surgical stereomicroscope, in which illumination incoupling occurs simultaneously into the main and assistant observers' beam paths, by way of four semitransparent and fully mirror-coated deflection elements arranged crosswise and symmetrically with respect to the optical axis of the main objective. The principal field of application here is the field of ophthalmic surgical procedures using the so-called red reflex. Illumination light reflected at the retina of the patient's eye produces a red background illumination in which details of the anterior segment of the eye can readily be detected by the surgeon. For this, the illumination beam path must optimally be incoupled at a small angle (from approximately 0° to 6°) to the observation beam path. The problem often occurs that the main observer and assistant observer, who should in fact see the same thing, obtain different red reflexes.

The aforementioned illumination incoupling system according to DE 102 08 594 A1 provides, in a first embodiment, for four deflection elements that couple two illumination beam paths via the main objective into the four observers' beam paths. Arranged in the direction of an illumination beam path is firstly a partially reflective deflection element, which is followed by a fully reflective deflection element. An arrangement of the deflection elements that is crosswise and symmetrical with respect to the optical axis of the main objective results in homogeneous illumination of the object field both for the main observer's beam paths and for the assistant observer's beam paths. With this embodiment, the two illumination beam paths are perpendicular to one another before deflection, and intersect in the axis of the main objective. In a second embodiment of the illumination incoupling system according to DE 102 08 594 A1, the respective first deflection element, onto which an illumination beam path is incident, is divided into multiple zones that are embodied to be transparent, semitransparent, or fully reflective. In a context of largely homogeneous illumination, the two illumination beam paths can thereby be guided, before they are deflected, at an angle appreciably less than 90° with respect to one another. Also proposed are embodiments having only two deflection elements as well as one or two illumination beam paths; here as well, it is essential that each deflection element be arranged in such a way that it reflects illumination light simultaneously both into one of the main observer's beam paths and into one of the assistant observer's beam paths.

In summary, it is noteworthy that the surgical microscopes of the aforesaid kind often exhibit disadvantages with regard to the following points: poorer red reflex (or none at all) on the assistant's channel and video output (documentation channel); image rotation at the video output when the assistant's tube is pivoted 180°; greater-than-optimum overall height of the surgical microscope; difficulties in positioning a main illumination in addition to the red reflex illumination for existing microscope objectives; reduced transmission on the main observer's channel; and reflections on the cornea of the patient's eye.

### SUMMARY OF THE INVENTION

The object of the present invention is to describe a four-beam stereomicroscope, in particular for ophthalmic surgery, in which red reflex illumination on all four beam paths is improved, the intention being to avoid as much as possible the aforementioned disadvantages of the existing art.

This object is achieved according to the present invention by a stereomicroscope as described in this specification.

The four-beam stereomicroscope according to the present invention of the kind recited previously, having stereo bases of the main observer's and assistant observer's beam paths that intersect at an angle, encompasses a device for illumination incoupling which comprises an illumination deflection element that is arranged in such a way that illumination light is couplable simultaneously, at least in part, into all four observation beam paths, imaginary connecting lines extending perpendicular to and between the axes respectively of an assistant observer's beam path and of a main observer's beam path, and the illumination deflection element being arranged in such a way that two parallel connecting lines are located in the plane of the illumination deflection element.

This arrangement of the illumination deflection element, in particular of a single illumination deflection element for red reflex illumination, is notable for the fact that with a low overall height all four observation beam paths are covered at least in part, so that illumination light can be coupled simultaneously into all four observation beam paths. With previously known approaches having only one deflection element for red reflex illumination, said element covered at least in part only the two main observer's beam paths. Because this deflection element is arranged obliquely in the direction of the beam path, usually at an angle of 45° with respect to the axes of the observers' beam paths, a further extension of the deflection element in order to cover the assistant observer's beam paths as well would greatly increase the overall height of the microscope. The arrangement proposed according to the present invention avoids this. Expressed in simplified fashion, the deflection element is rotated, as compared with the previous arrangement (coverage only of the main observer's beam paths) through an angle of approximately 45° when seen in plan view, so that all four observation beam paths are covered at least in part. If a connecting line is imagined between a first main observer's beam path and a first assistant's beam path; and a further connecting line, parallel thereto, is imagined between a second main observer's beam path and a second assistant's beam path, it is then possible to construct two parallel connecting lines that are located in the plane of the illumination deflection element.

This novel arrangement of, in particular, a single deflection element for red reflex illumination makes possible a red reflex on both the main observer's channel and the assistant's channel, while the overall height of the surgical microscope remains the same. Cornea reflections can at the same time be limited, specifically to a maximum of two reflections when two illumination beam paths are used for red reflex illumination, and to one cornea reflection when only one illumination beam path is used.

The illumination deflection element is embodied (i.e. dimensioned and oriented) in such a way that in plan view it covers at least 50%, in particular between 50% and 75%, of each pupil of the observation beam paths.

It is advantageous to direct the illumination light in the form of two illumination beam paths onto the illumination deflection element. These two illumination beam paths can overlap on the illumination deflection element, and after deflection are coupled into the four observation beam paths. When two illumination beam paths are used, the diameters of the individual illumination beam paths can be kept comparatively small, whereas with the use of exactly one illumination beam path the diameter of that beam path must be correspondingly enlarged to allow incoupling into all four observation beam paths. The larger the diameter of the illumination beam path or paths, however, the greater the risk of objectionable reflections, in particular from the center of the objective.

To avoid such reflections from the center of the objective, it is advantageous if the main axis of the main objective of the stereomicroscope is arranged decenteredly with respect to the four surrounding observation beam paths. In other words, the intersection point or crossing point of the aforementioned stereo bases is not located on the main axis of the main objective. This embodiment is particularly advantageous, in terms of reflection reduction, in combination with the use of two illumination beam paths to deliver illumination light to the illumination deflection element arranged according to the present invention, when a region around the center of the objective is left untouched by illumination light.

With the stereomicroscope according to the present invention there are in principle two different possibilities for outcoupling the main observer's beam paths, and analogously also the assistant observer's beam paths.

According to a first possibility for outcoupling the main observer's beam paths into a main observer's tube of the stereomicroscope, the latter comprises at least one main observer's outcoupling element for respectively deflecting one main observer's beam path, the main observer's outcoupling elements being arranged in such a way that the main observer's beam paths can be outcoupled toward the main observer in a parallel direction perpendicular to the two imaginary parallel connecting lines. The result of this is that the beam paths traveling into the main observer's tube possess, after outcoupling, a stereo base that is rotated through an angle with respect to the stereo base before outcoupling. The same observations can be made analogously for the assistant observer's beam paths.

According to a second possibility for outcoupling the main observer's beam paths into a main observer's tube of the stereomicroscope, the latter comprises at least one main observer's outcoupling element for respectively deflecting one main observer's beam path, the main observer's outcoupling elements being arranged in such a way that the main observer's beam paths can be outcoupled toward the main observer in a parallel direction perpendicular to the stereo base of the main observer's beam paths. In this case the respective stereo bases are parallel to one another before and after outcoupling of the main observer's beam paths.

While the first possibility is physically more slender, since (as has hitherto been usual) it outcouples the main observer's beam paths in a direction which is parallel to that direction in which the illumination beam path or paths is/are delivered to the stereomicroscope, the second possibility for outcoupling of the main observer's beam paths avoids a rotation of the stereo base, although it produces a more highly angular construction when the design of the surgical microscope is implemented. An angular construction of this kind can have more corners and edges, which should be avoided in surgical microscopes with their sterile protective envelopes.

Without discussing them individually and separately, the same considerations apply to outcoupling of the assistant observer's beam paths.

In order to compensate for an optical path length difference that occurs between the two (outcoupled) main observer's beam paths, advantageously one or more optical path length compensation elements are provided in one of the two main beam paths. A plane-parallel glass piece can, for example, increase the optical path length in that main beam path which, after outcoupling, would need to travel over a shorter optical path length to the viewer's eye.

So-called Dove prisms can be used to compensate for a possible image skewing as a result of rotation of a stereo base upon outcoupling. Such prisms can be used to rotate a beam, in this case the main observer's and/or assistant observer's beam path, through a predetermined angle. The skewing of the stereo base can thereby be compensated for.

With regard to the compensation elements for optical path length compensation and for compensating for image skewing, the considerations that apply to the assistant observer's beam paths are analogous to those for the main observer's beam paths.

Further advantages and embodiments of the invention are evident from the description and the attached drawings.

It is understood that the features recited above and those yet to be explained below are usable not only in the respective combination indicated, but also in other combinations or in isolation, without departing from the scope of the present invention.

### BRIEF DESCRIPTION OF THE DRAWING VIEWS

The invention is schematically depicted in the drawings on the basis of an exemplifying embodiment and will be described in detail below with reference to the drawings.

FIG. 1 is a schematic plan view of the main objective of a four-beam stereomicroscope with the pupils, located in the objective plane, of the main observer's and assistant observer's beam paths;

FIG. 2 schematically shows an embodiment of an illumination incoupling system in the context of an observation arrangement according to FIG. 1;

FIG. 3 is a schematic side view of the embodiment according to FIG. 2;

FIG. 4 is a schematic perspective view of an embodiment of the outcoupling of the main observer's beam paths; and

FIGS. 5a and 5b are schematic perspective views of an embodiment for outcoupling the assistant observer's beam paths, the outcoupling system according to FIG. 5b being rotated 180° with respect to the outcoupling according to FIG. 5a.

### DETAILED DESCRIPTION OF THE INVENTION

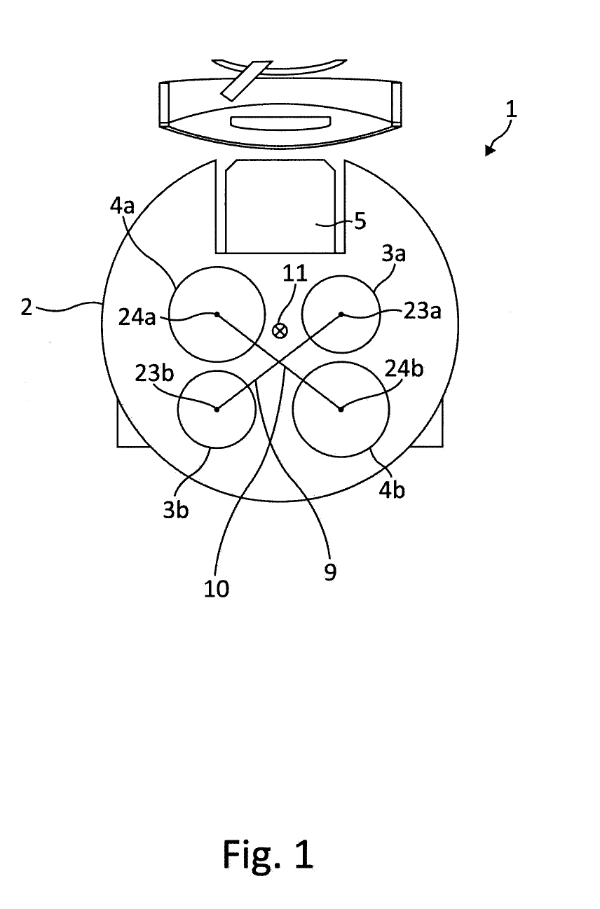

FIG. 1 is a schematic plan view of main objective 2 of a stereomicroscope 1, in this case an ophthalmic surgical microscope. This is a four-beam surgical microscope in which, consequently, a respective binocular beam path is available for stereoscopic object viewing both to the assistant observer (auxiliary observer) and to the main observer (surgeon). The main observer's and assistant observer's beam paths pass through main objective 2 in the objective plane (drawing plane of FIG. 1), thereby forming the depicted pupils 4a and 4b of the main observer's beam paths and pupils 3a and 3b of the assistant observer's beam paths. The centers of pupil pair 3a, 3b of the assistant observer's beam paths are connected by the (imaginary) stereo base 9, while the centers of pupil pair 4a, 4b of the main observer's beam paths are connected by the (imaginary) stereo base 10. Stereo bases 9 and 10 intersect at an angle that, in the exemplifying embodiment depicted, deviates from 90° because of a slight asymmetry. It is apparent that the crossing point of stereo bases 9 and 10 is not located on main axis 11 (which is perpendicular to the drawing plane) of main objective 2. As already stated above, this helps to avoid objectionable reflections from the center of the objective.

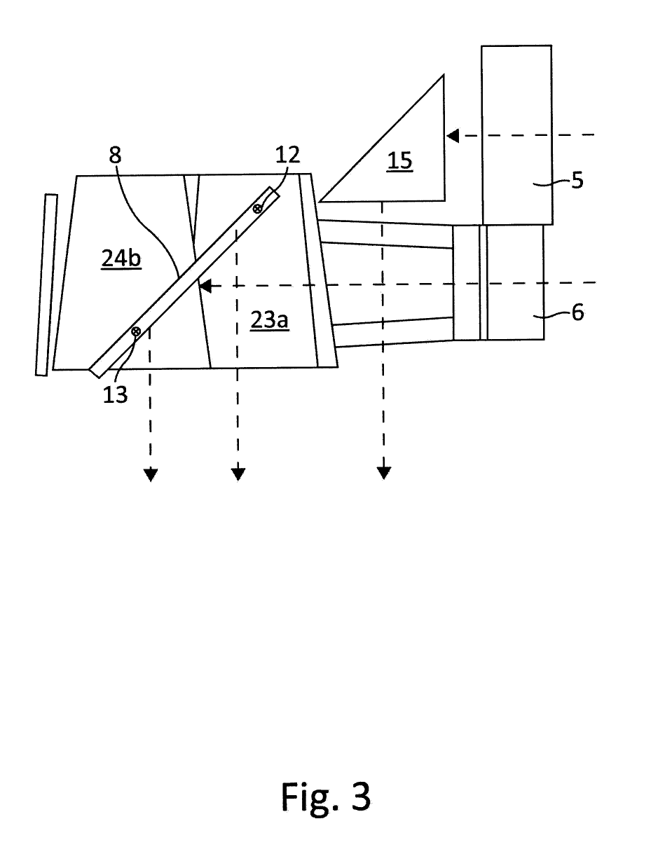

Also visible in FIG. 1 is main illumination unit 5, which directs a main illumination beam path via main objective 2 toward the object plane (see also FIG. 3). What will be discussed below in the context of the stereomicroscope 1 depicted is not so much the main illumination as the red reflex illumination. Unless otherwise indicated hereinafter, the term “illumination” is therefore assumed to refer to the red reflex illumination.

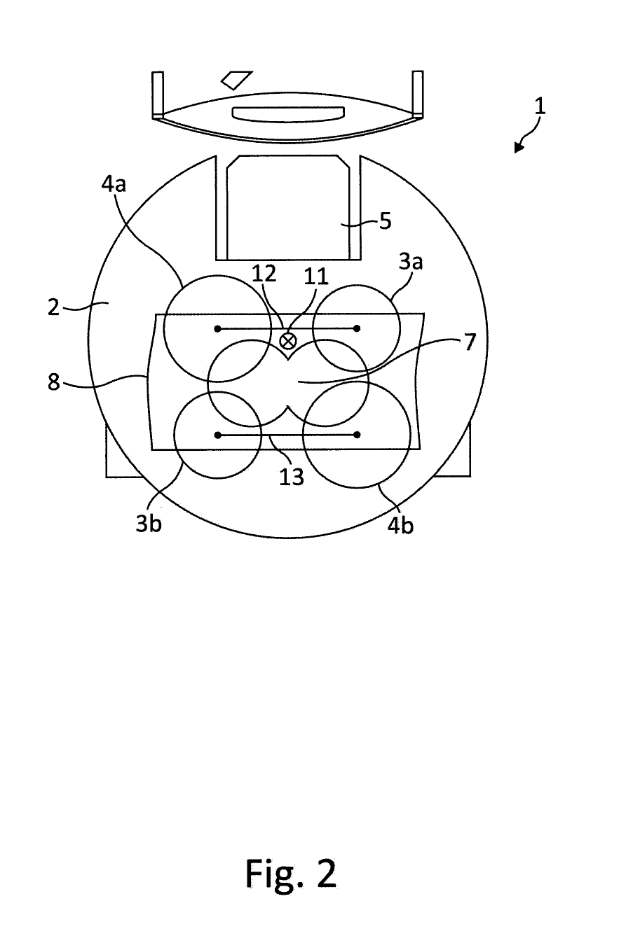

FIG. 2 now shows, in a schematic plan view in the context of an arrangement according to FIG. 1, an embodiment for illumination incoupling of the red reflex illumination having an illumination deflection element 8. Red reflex illumination unit 6 (see FIG. 3) generates (at least) one illumination beam path that is incident onto deflection element 8 perpendicular to the observers' beam paths toward said element. Connecting line 12 is an (imaginary) connecting line between the axes of main observer's beam path 24a and of assistant observer's beam path 23a, the projection of which onto the objective plane extends from the center of pupil 4a to the center of pupil 3a. In the plan view according to FIG. 2, all the imaginary connecting lines perpendicular to and between the axes of main observer's beam path 24a and of assistant's beam path 23a fall onto the depicted connecting line 12.

A second connecting line can be drawn in the objective plane between the center of pupil 3b and the center of pupil 4b. In the view according to FIG. 2, all further imaginary lines, among them connecting line 13, perpendicular to and between the axes of assistant's beam path 23b and of main observer's beam path 24b coincide with the depicted connecting line 13.

As is apparent from FIG. 3, illumination deflection element 8 is arranged a 45-degree angle with respect to the direction of the observers' beam paths in order to couple the incident illumination light at a 90-degree angle into the observation beam paths and parallel thereto. Deflection element 8 is oriented with reference to the main observer's and assistant observer's beam paths in such a way that the two parallel connecting lines 12 and 13 are located in the plane of deflection element 8. Deflection element 8 thus at least in part covers all four observers' beam paths, with the result that illumination light can be coupled simultaneously, at least in part, into all four observers' beam paths 24a, 24b and 23a, 23b. At the same time, this occurs in a space-saving manner with respect to the overall height of stereomicroscope 1.

As is evident from FIG. 2, illumination deflection element 8 covers at least 50%, in particular up to 75% (see FIG. 3) of pupils 3a, 3b and 4a, 4b of the observation beam paths.

The portion of pupils 3a, 3b and 4a, 4b that is actually illuminated results from the intersection area between those pupils and profile 7 of the red reflex illumination incoupled via deflection element 8. As is evident from FIG. 2, profile 7 corresponds to the profile of two overlapping illumination beam paths of red reflex illumination unit 6 (see FIG. 3). Profile 7 that is depicted illustrates the fact that the center of the objective, located on main axis 11 of main objective 2, can be left untouched by illumination. This additionally prevents objectionable reflections from the center of the objective. If profile 7 that is depicted were notionally replaced with a profile that had been generated by a single illumination beam path, it is evident that sufficient coverage of pupils 3a, 3b and 4a, 4b, for sufficient incoupling of illumination light, would be possible only if the diameter of the illumination beam path is selected to be so large that in the case depicted here, the center of the objective would be enclosed by the profile of the illumination beam path. The arrangement depicted here, having two illumination beam paths, is to be preferred in that regard.

The depiction in FIG. 2 shows graphically that both the assistant observer and the main observer receive a good red reflection. At the same time, reflections on the cornea of the patient's eye in the context of two illumination pupils are reduced to two cornea reflections.

FIG. 3 is a schematic side view of the arrangement depicted in FIG. 2 for illumination incoupling. Main observer's beam path 24b and assistant observer's beam path 23a, which respectively conceal observers' beam paths 23b and 24a located behind them, are depicted with slight perspective. Illumination deflection element 8 for red reflex illumination is clearly visible. A main illumination deflection element 15, which deflects the main illumination beam path toward main objective 2, is provided for main illumination. The red reflex illumination unit is labeled 6. It generates two illumination beam paths that are incident onto deflection element 8. It is thereby possible, as is apparent from FIG. 3, for the illumination light to be coupled into the observers' beam paths at a small angle with respect to the axes of the observers' beam paths. The fact that deflection element 8 covers almost 75% of the observation beam paths can also be gathered from the depiction according to FIG. 3.

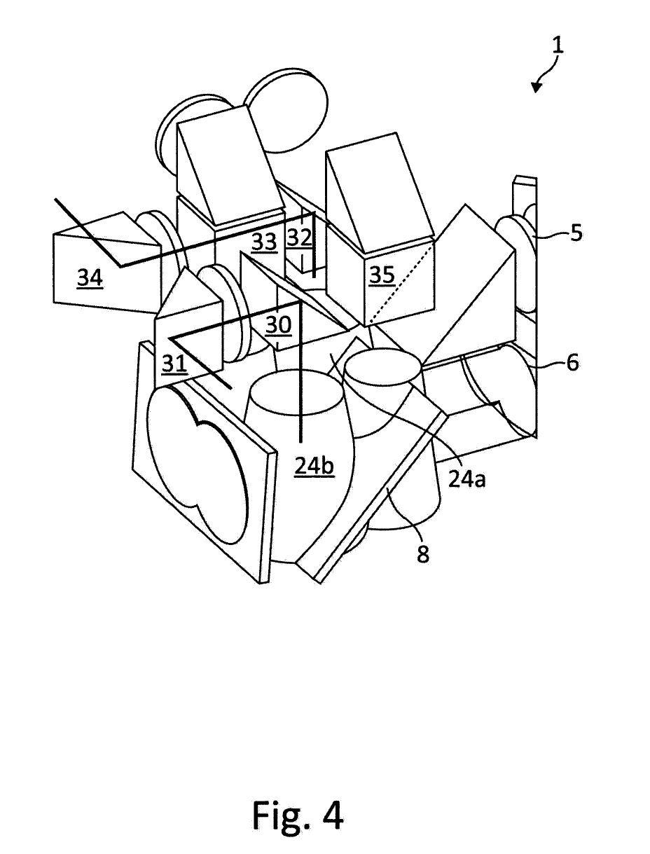

FIG. 4 is a perspective depiction of the configuration shown in FIG. 3, supplemented with a device for outcoupling main observer's beam paths 24a and 24b. Outcoupling elements 30, 31 for main observer's beam path 24b, and 32, 34 for main observer's beam path 24a, are depicted. Only the axes of the outcoupled observer's beam paths are depicted in FIG. 4. Outcoupling elements 31 and 34 are followed by a binocular tube for the main observer. The viewing direction of the main observer extends parallel to the direction of the beam path between outcoupling elements 30, 31 and 32, 34 respectively. This direction extends parallel to the directions perpendicular to the two imaginary parallel connecting lines 12 and 13. Outcoupling thus occurs “in the illumination direction,” which corresponds to the classic slender arrangement of surgical microscopes.

As is apparent from FIG. 4, in this case the stereo base is rotated with respect to stereo base 10 after outcoupling of the main observer's beam paths (see FIG. 1). A Dove prism can be used to compensate for any image skewing due to the rotation of the stereo base. In addition, a compensation element 33 is used in the embodiment depicted according to FIG. 4 in order to compensate for different glass travel lengths of the outcoupled main observer's beam paths 24a and 24b.

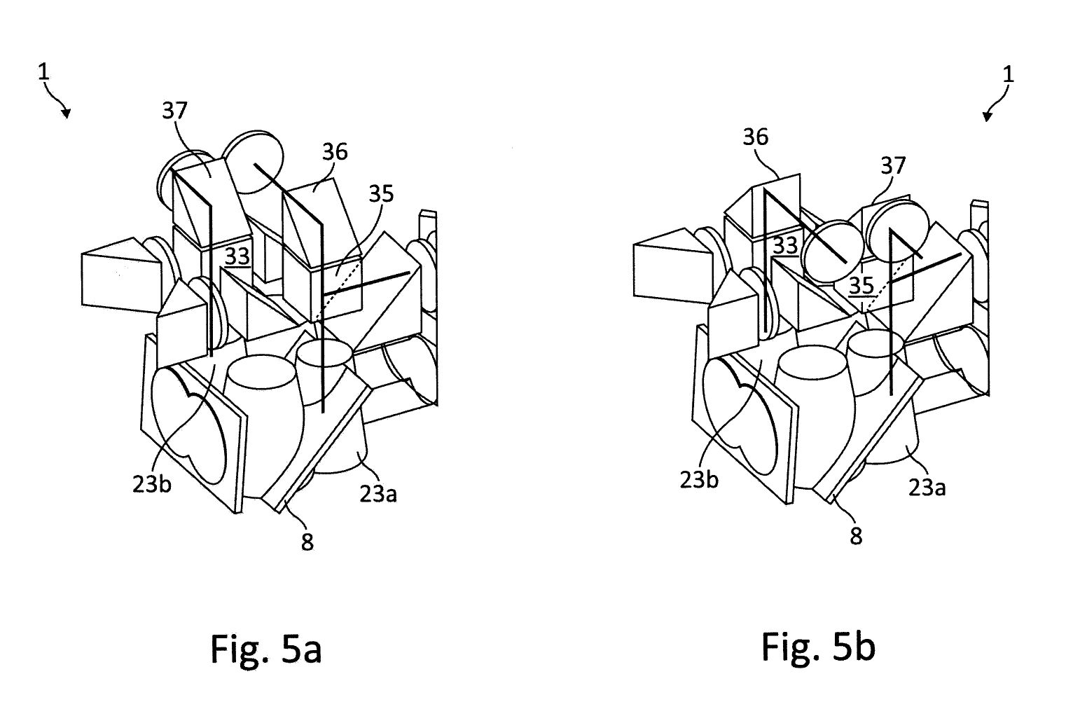

FIGS. 5a and 5b show, in the same schematic view as FIG. 4, a device for outcoupling assistant observer's beam paths 23a and 23b. Only the axes of the outcoupled observer's beam paths are depicted. Beam path 23a is directed via outcoupling element 36, and beam path 23b via outcoupling element 37, into a binocular tube for the assistant observer. Outcoupling elements 36 and 37 are 90-degree deflection prisms. Outcoupling element 35 performs the function of coupling out a documentation beam path (axis extends in the direction of deflection element 15).

FIG. 5a shows an arrangement rotated 180 degrees with respect to the arrangement according to FIG. 5b. In the context of this rotation, outcoupling elements 36 and 37 are rotated 180 degrees; they can, for example, change places, as shown in FIGS. 5a and 5b. This rotation has no influence on the outcoupling of the main observer's beam paths. The assistant's beam paths, on the other hand, are outcoupled in a direction rotated 180°. The 180-degree rotation also has no influence on the outcoupled documentation beam path. The outcoupling depicted here of the assistant's beam paths and/or of the documentation beam path is independent of the embodiment specifically depicted in FIGS. 5a and 5b and also of, in particular, the manner in which the main beam paths are outcoupled or the manner in which illumination deflection element 8 is arranged.

### PARTS LIST

1 Stereomicroscope
2 Main objective
3a, 3b Pupil of assistant observer's beam path
4a, 4b Pupil of main observer's beam path
5 Main illumination unit
6 Red reflex illumination unit
7 Profile of red reflex illumination
8 Illumination deflection element
9 Stereo base of assistant observer's beam paths
10 Stereo base of main observer's beam paths
11 Main axis of objective
12 First connecting line, main observer's and assistant observer's beam path
13 Second connecting line, main observer's and assistant observer's beam path
13 Main illumination deflection element
23a, 23b Assistant observer's beam path
24a, 24b Main observer's beam path
30 Outcoupling element
31 Outcoupling element
32 Outcoupling element
33 Compensation element
34 Outcoupling element
35 Outcoupling element
36 Outcoupling element
37 Outcoupling element

What is claimed is:

1. A stereomicroscope (1) comprising:
a main objective (2) defining an objective plane;
two main observer's beam paths (24a, 24b) and two assistant observer's beam paths (23a, 23b) passing through the main objective (2), each of the four observation beam paths (24a, 24b; 23a, 23b) having a respective beam axis, wherein pupils (4a, 4b; 3a, 3b) of the two main observer's beam paths and pupils of the two assistant observer's beam paths are respectively formed in the objective plane, the pupil pair formed by the two main observer's beam paths being connected by a first stereo base (10) and the pupil pair formed by the two assistant observer's beam paths being connected by a second stereo base (9), and wherein the first and second stereo bases (10, 9) intersect at an angle;
a device for illumination incoupling, the incoupling device including an illumination deflection element (8) arranged such that illumination light is couplable simultaneously, at least in part, into all four observation beam paths (24a, 24b; 23a, 23b), the illumination deflection element (8) defining a plane;
the illumination deflection element (8) being arranged such that a pair of parallel imaginary connecting lines (12, 13) are located in the plane of the illumination deflection element (8), one of the pair of connecting lines (12) extending perpendicular to and between the respective axes of one of the two assistant observer's beam paths and one of the two main observer's beam paths, and another of the pair of connecting lines (13) extending perpendicular to and between the respective axes of another of the two assistant observer's beam paths and another of the two main observer's beam paths.

2. The stereomicroscope according to claim 1, wherein the illumination deflection element (8) is arranged between the main objective (2) and a binocular tube or a magnification changer of the stereomicroscope (1).

3. The stereomicroscope according to claim 1, wherein the illumination deflection element (8), in plan view, covers at least 50% of each of the pupils (3a, 3b; 4a, 4b) formed by the two main observer's beam paths and the two assistant observer's beam paths.

4. The stereomicroscope according to claim 3, wherein the illumination deflection element (8), in plan view, covers between 50% and 75% of each of the pupils (3a, 3b; 4a, 4b).

5. The stereomicroscope according to claim 1, wherein the illumination light is deliverable to the stereomicroscope (1) toward the illumination deflection element (8) in a direction perpendicular to the four observers' beam paths, wherein a surface normal line of the illumination deflection element (8) encloses an angle in a range from α>0 to α<90° with an axis of one of the observer's beam paths.

6. The stereomicroscope according to claim 5, wherein the enclosed angle α=45°.

7. The stereomicroscope according to claim 1, wherein the illumination light is deliverable to the stereomicroscope in the form of exactly one illumination beam path.

8. The stereomicroscope according to claim 1, wherein the illumination light is deliverable to the stereomicroscope in the form of exactly two illumination beam paths.

9. The stereomicroscope according to claim 1, wherein the objective (2) has a main axis (11), and wherein an intersection point of the first and second stereo bases (10, 9) is spaced from the main axis (11).

10. The stereomicroscope according to claim 1, wherein the first and second stereo bases (10, 9) intersect at an angle not equal to 90°.

11. The stereomicroscope according claim 1, further comprising a device for outcoupling the assistant observer's beam paths (23a, 23b) into an assistant's tube and the main observer's beam paths (24a, 24b) into a main observer's tube of the stereomicroscope (1), the outcoupling device having at least one outcoupling element (30, 31; 32, 34) for respectively deflecting one main observer's beam path (24b; 24a), the main observer's outcoupling elements being arranged such that the main observer's beam paths (24a, 24b) can be outcoupled toward the main observer in a parallel direction perpendicular to the two imaginary parallel connecting lines (12, 13).

12. The stereomicroscope according to claim 1, further comprising a device for outcoupling the assistant observer's beam paths (23a, 23b) into an assistant's tube and the main observer's beam paths (24a, 24b) into a main observer's tube of the stereomicroscope (1), the outcoupling device having at least one outcoupling element (30, 31; 32, 34) for respectively deflecting one main observer's beam path (24b; 24a), the main observer's outcoupling elements being arranged in such a way that the main observer's beam paths (24a, 24b) can be outcoupled toward the main observer in a parallel direction perpendicular to the first stereo base (10) of the main observer's beam paths.

13. The stereomicroscope according to claim 11, wherein at least one optical path length compensation element (33) is provided in one of the two main observer's beam paths (24a, 24b) in order to compensate for an optical path length difference between the two main observer's beam paths.

14. The stereomicroscope according to claim 11, wherein at least one optical image rotation compensation element is provided in observers' beam paths in order to compensate for a rotation of a stereo base (10, 9) of the main observer's beam paths and/or the assistant observer's beam paths.

15. The stereomicroscope according to claim 14, wherein the at least one optical image rotation compensation element includes a Dove prism.
